(19) United States
(12) Patent Application Publication
(10) Pub. No.: US 2026/0147295 A1
(43) Pub. Date: May 28, 2026

(54) FIXING DEVICE, IMAGE FORMING APPARATUS, AND FIXING METHOD

(71) Applicant: Teppei Kawata, KANAGAWA (JP)

(72) Inventor: Teppei Kawata, KANAGAWA (JP)

(73) Assignee: Ricoh Company, Ltd., Tokyo (JP)

(21) Appl. No.: 19/394,317

(22) Filed: Nov. 19, 2025

(30) Foreign Application Priority Data
Nov. 25, 2024 (JP) 2024-204906

(51) Int. Cl. G03G 15/20; G03G 15/00

(52) U.S. Cl. CPC G03G 15/2032; G03G 15/2028; G03G 15/2064; G03G 15/6594; G03G 2215/00514; G03G 2215/00599; G03G 2215/2025

(57) ABSTRACT

A fixing device includes a pressure roller that presses against a fixing roller via a fixing belt to form a nip portion. A mover moves the pressure roller in an approach direction in which the pressure roller approaches the fixing belt and a separation direction in which the pressure roller separates from the fixing belt. A linear speed sensor detects a linear speed of the fixing belt in a state in which the pressure roller separates from the fixing belt. Processing circuitry calculates an amount of thermal expansion of the fixing roller in a radial direction thereof based on the linear speed of the fixing belt, and controls the mover to move the pressure roller based on the amount of thermal expansion of the fixing roller to adjust an amount of pressure applied by the pressure roller to the fixing roller.

### CROSS-REFERENCE TO RELATED APPLICATION

This patent application is based on and claims priority pursuant to 35 U.S.C. § 119(a) to Japanese Patent Application No. 2024-204906, filed on Nov. 25, 2024, in the Japan Patent Office, the entire disclosure of which is hereby incorporated by reference herein.

### BACKGROUND

### Technical Field

The present disclosure relates to a fixing device, an image forming apparatus, and a fixing method.

### Related Art

Related-art image forming apparatuses, such as copiers, printers, facsimile machines and multifunction peripherals (MFP) having two or more of copying, printing, scanning, facsimile, plotter, and other functions, typically form an image on a recording medium according to image data by electrophotography.

For example, such image forming apparatuses include a fixing device including a heating roller, a fixing roller, an endless belt stretched across the heating roller and the fixing roller, and a pressure roller. The fixing roller and the pressure roller form a fixing nip between the endless belt and the pressure roller. As a recording medium bearing a toner image is conveyed through the fixing nip, the fixing device fixes the toner image on the recording medium.

### SUMMARY

The present disclosure described herein provides a fixing device that includes a fixing belt that is endless and a heater that heats the fixing belt. A support roller supports the fixing belt rotatably. A fixing roller supports the fixing belt rotatably. A pressure roller presses against the fixing roller via the fixing belt to form a nip portion between the fixing belt and the pressure roller, through which at least one recording medium is conveyed. A mover moves the pressure roller with respect to the fixing roller in an approach direction in which the pressure roller approaches the fixing belt and a separation direction in which the pressure roller separates from the fixing belt. A linear speed sensor detects a linear speed of the fixing belt in a state in which the pressure roller separates from the fixing belt. Processing circuitry calculates an amount of thermal expansion of the fixing roller in a radial direction of the fixing roller based on the linear speed of the fixing belt, and controls the mover to move the pressure roller based on the amount of thermal expansion of the fixing roller to adjust an amount of pressure applied by the pressure roller to the fixing roller.

The present disclosure described herein further provides an image forming apparatus that includes an image bearer that bears an image and the fixing device described above that fixes the image on at least one recording medium.

The present disclosure described herein further provides a fixing method that includes receiving a print job, determining that a recording medium specified in the print job is an envelope, determining a nip width of a nip portion formed between a fixing belt and a pressure roller to be set based on a type of the envelope, the nip width being in a circumferential direction of the pressure roller, obtaining a current linear speed of the fixing belt, calculating an amount of pressure applied by the pressure roller based on the nip width preset for the type of the envelope and the current linear speed of the fixing belt, controlling the amount of pressure applied by the pressure roller, and starting conveyance of the envelope.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of a fixing device according to an embodiment of the present disclosure;

FIG. 2 is a block diagram of a hardware configuration of the fixing device depicted in FIG. 1 as one example;

FIG. 3 is a block diagram of a functional configuration of a controller incorporated in the fixing device depicted in FIG. 2;

FIG. 4 is a graph illustrating a relation between a linear speed of a fixing belt and a nip width of a nip portion incorporated in the fixing device depicted in FIG. 1;

FIG. 5 is a timing chart of processes performed by the fixing device depicted in FIG. 2 when recording media are conveyed through the fixing device;

FIG. 6 is a flowchart illustrating processes performed by the fixing device depicted in FIG. 2 from reception of a print job until start of conveyance of a recording medium; and

FIG. 7 is a schematic diagram of an image forming apparatus according to an embodiment of the present disclosure, that incorporates the fixing device depicted in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to drawings, a description is provided of constructions of a fixing device and an image forming apparatus, respectively, according to embodiments of the present disclosure.

A description is provided of a construction of a fixing device 100.

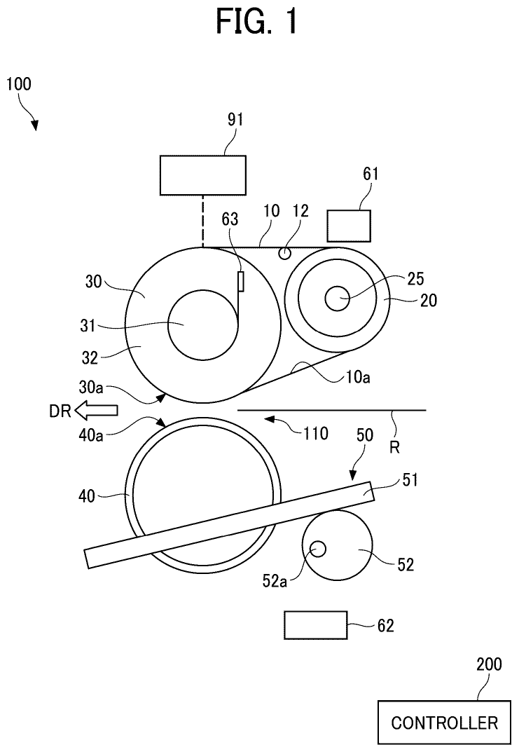

FIG. 1 is a schematic diagram of the fixing device 100 according to an embodiment of the present disclosure. As illustrated in FIG. 1, the fixing device 100 includes a fixing belt 10, a heating roller 20, a fixing roller 30, a pressure roller 40, a presser 50, a linear speed sensor 61, and a controller 200.

A description is provided of a configuration of the fixing belt 10.

The fixing belt 10 is an endless belt that is stretched across the heating roller 20 and the fixing roller 30. The fixing belt 10 rotates in accordance with rotation of the fixing roller 30.

A description is provided of a configuration of the heating roller 20.

The heating roller 20 rotates in accordance with rotation of the fixing belt 10. As the heating roller 20 rotates, the heating roller 20 heats the fixing belt 10. The fixing device 100 further includes a heater 25 that heats the heating roller 20. The heating roller 20 generates heat that is conducted to the fixing belt 10.

A description is provided of a construction of the fixing roller 30.

The fixing roller 30 includes a core metal 31 and a rubber layer 32. The core metal 31 is disposed at a center of the fixing roller 30. The rubber layer 32 is mounted on an outer face of the core metal 31 in a radial direction of the fixing roller 30. The rubber layer 32 coats the core metal 31 throughout an entire periphery thereof. The fixing roller 30 includes an outer circumferential face 30a as an outer circumferential face of the rubber layer 32. The fixing roller 30 may have an outer diameter that is greater than an outer diameter of the heating roller 20. The rubber layer 32 of the fixing roller 30 expands thermally. Accordingly, the outer diameter of the fixing roller 30 increases. The fixing device 100 further includes a temperature sensor 63 that detects a temperature of the fixing roller 30.

The fixing device 100 further includes a driving motor 91 that is coupled with the fixing roller 30. The driving motor 91 generates a driving force that is transmitted to the fixing roller 30. The driving force transmitted to the fixing roller 30 rotates the fixing roller 30.

A description is provided of a construction of the pressure roller 40.

The pressure roller 40 is disposed opposite the outer circumferential face 30a of the fixing roller 30. The pressure roller 40 has an outer circumferential face 40a that is pressed against the outer circumferential face 30a of the fixing roller 30 via the fixing belt 10, thus forming a nip portion 110 between the outer circumferential face 40a of the pressure roller 40 and the fixing belt 10. A recording medium R is conveyed through the nip portion 110.

A description is provided of a construction of the presser 50.

The presser 50 moves the pressure roller 40 with respect to the fixing roller 30 in an approach direction in which the pressure roller 40 approaches the fixing belt 10 and the fixing roller 30 and a separation direction in which the pressure roller 40 separates from the fixing belt 10. For example, the presser 50 includes a cam 52 and an arm 51. As the cam 52 rotates, the arm 51 contacting the cam 52 causes the pressure roller 40 to approach the fixing belt 10 and the fixing roller 30 and causes the pressure roller 40 to separate from the fixing belt 10. The presser 50 may further include a driver, a driving force transmitter, and a support. The driver moves the pressure roller 40. The driving force transmitter transmits a driving force generated by the driver. The support supports the pressure roller 40 movably.

As the presser 50 causes the pressure roller 40 to approach the fixing belt 10 and the fixing roller 30, the presser 50 decreases a gap between the fixing roller 30 and the pressure roller 40. As the presser 50 separates the pressure roller 40 from the fixing belt 10, the presser 50 increases the gap between the fixing roller 30 and the pressure roller 40.

A description is provided of a configuration of the linear speed sensor 61.

The linear speed sensor 61 detects a linear speed of the fixing belt 10. The linear speed of the fixing belt 10 may define a rotational speed of the fixing belt 10. For example, the linear speed sensor 61 may detect an angle of rotation of a rotation shaft of the heating roller 20 to calculate the rotational speed of the fixing belt 10. The linear speed sensor 61 may detect data relating to the linear speed of the fixing belt 10.

A description is provided of a hardware configuration of the fixing device 100.

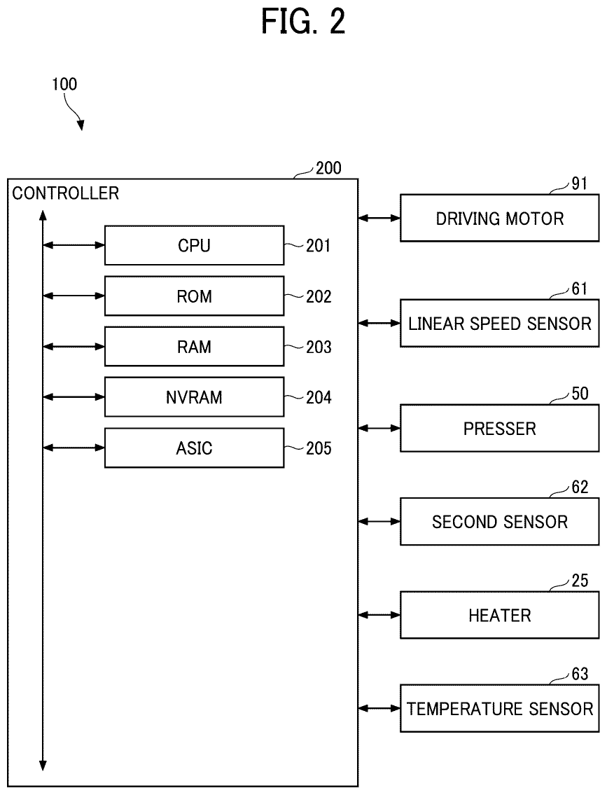

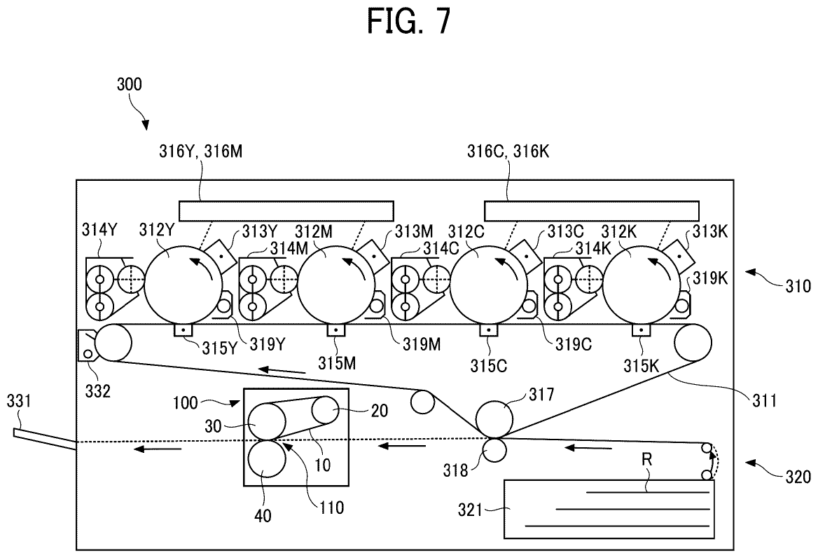

FIG. 2 is a block diagram of the hardware configuration of the fixing device 100 according to the embodiment. As illustrated in FIG. 2, the fixing device 100 further includes a second sensor 62. The controller 200 is coupled with the driving motor 91, the linear speed sensor 61, the presser 50, and the second sensor 62. The controller 200 may be installed in an image forming apparatus 300 described below with reference to FIG. 7 and may control an entirety of the image forming apparatus 300.

As illustrated in FIG. 1, the cam 52 includes a rotation shaft 52a. The second sensor 62 detects an angle of rotation of the rotation shaft 52a of the cam 52 of the presser 50. The second sensor 62 sends a detection result to the controller 200. The controller 200 detects the angle of rotation of the cam 52 based on the detection result, that is, detected data, and calculates a nip width of the nip portion 110. The nip width defines a width of the nip portion 110 in a circumferential direction of the pressure roller 40, that is formed when the pressure roller 40 contacts the fixing belt 10. Alternatively, the second sensor 62 may be replaced with other sensors, for example, a sensor that detects a position of the arm 51, a position of the pressure roller 40, or the nip width of the nip portion 110. The fixing device 100 incorporates the temperature sensor 63 that detects a temperature of the core metal 31 of the fixing roller 30.

The controller 200 includes a central processing unit (CPU) 201, a read-only memory (ROM) 202, and a random-access memory (RAM) 203. The CPU 201 controls an entirety of the fixing device 100. The ROM 202 stores fixed data such as programs executed by the CPU 201. The RAM 203 stores image data and the like temporarily.

The controller 200 further includes a non-volatile random-access memory (NVRAM) 204 and an application-specific integrated circuit (ASIC) 205. The NVRAM 204 is a nonvolatile memory that retains data even while the fixing device 100 is powered off. The ASIC 205 performs various signal processing with respect to image data, image processing for rearrangement and the like, and input-output signal processing for controlling the entirety of the fixing device 100.

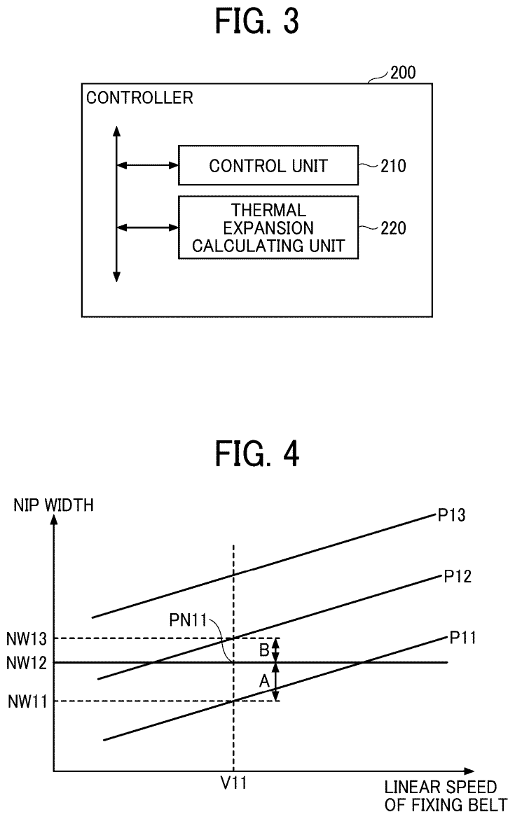

Referring to FIG. 3, a description is provided of a functional configuration of the controller 200.

FIG. 3 is a functional block diagram of the controller 200 according to the embodiment of the present disclosure. As illustrated in FIG. 3, the controller 200 includes a control unit 210 and a thermal expansion calculating unit 220. The CPU 201 depicted in FIG. 2 executes the programs stored in a memory such as the ROM 202, achieving functions of the control unit 210 and the thermal expansion calculating unit 220. Alternatively, the controller 200 may be coupled with external devices and sensors that achieve a part of the functions described above.

A description is provided of a configuration of the thermal expansion calculating unit 220.

The thermal expansion calculating unit 220 calculates an amount of thermal expansion of the fixing roller 30 in the radial direction thereof based on the linear speed of the fixing belt 10. The memory of the controller 200 may store a map indicating a relation between the linear speed of the fixing belt 10 and the amount of thermal expansion of the fixing roller 30 in the radial direction thereof.

A description is provided of a configuration of the control unit 210.

The control unit 210 controls operations of the presser 50 based on the amount of thermal expansion of the fixing roller 30 in the radial direction thereof. The control unit 210 controls the operations of the presser 50, controlling an amount of pressure applied by the pressure roller 40. The amount of pressure applied by the pressure roller 40 may define the nip width of the nip portion 110. The control unit 210 controls a position of the pressure roller 40 relative to the fixing roller 30, controlling the nip width of the nip portion 110.

The control unit 210 may control operations of a motor that drives the cam 52 of the presser 50. The control unit 210 receives data relating to the angle of rotation of the rotation shaft 52a of the cam 52 from the second sensor 62. The control unit 210 determines a position of the pressure roller 40 based on the angle of rotation of the rotation shaft 52a of the cam 52. The control unit 210 determines whether or not the pressure roller 40 presses against the fixing roller 30 via the fixing belt 10 based on the position of the pressure roller 40. A state in which the pressure roller 40 presses against the fixing roller 30 via the fixing belt 10 also indicates a state in which the pressure roller 40 and the fixing roller 30 nip the recording medium R at the nip portion 110.

The control unit 210 controls operations of the driving motor 91, controlling rotation and halting of the fixing belt 10. The control unit 210 determines the linear speed of the fixing belt 10 based on data output from the linear speed sensor 61.

Referring to FIG. 4, a description is provided of a relation between the linear speed of the fixing belt 10 and the nip width of the nip portion 110.

FIG. 4 is a graph illustrating the relation between the linear speed of the fixing belt 10 and the nip width of the nip portion 110. FIG. 4 illustrates x-axis that represents the linear speed (e.g., a rotational speed) of the fixing belt 10 and y-axis that represents the nip width of the nip portion 110.

FIG. 4 illustrates the nip width of the nip portion 110 that changes as the linear speed of the fixing belt 10 changes when pressure applied at the nip portion 110 is released. The memory of the fixing device 100 stores in advance data relating to the nip width when the nip portion 110 is formed with a predetermined amount of pressure. The predetermined amount of pressure is applied by the pressure roller 40. The predetermined amount of pressure applied by the pressure roller 40 and the data relating to the nip width may be defined with a formula or a matrix table.

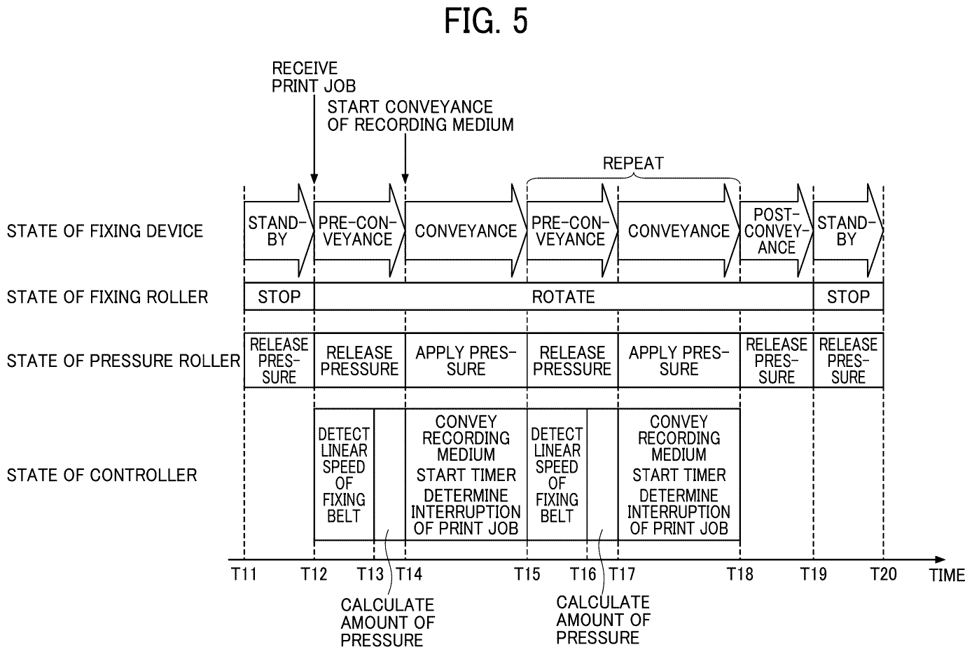

Referring to FIG. 5, a description is provided of processes performed by the fixing device 100 when recording media R are conveyed in a recording medium conveyance direction DR in FIG. 1.

FIG. 5 is a timing chart of the processes performed by the fixing device 100 in a recording medium conveyance state in which the recording medium R is conveyed through the fixing device 100. The memory of the fixing device 100 stores in advance the data relating to the nip width when the recording medium R (e.g., an envelope) is conveyed through the fixing device 100 according to a plurality of types of envelopes serving as the recording media R. Alternatively, the image forming apparatus 300 may incorporate a memory that stores the data relating to the nip width. The recording medium conveyance state may define a state in which the recording medium R is conveyed through the nip portion 110.

FIG. 5 illustrates x-axis that represents time that passes. FIG. 5 illustrates states of each of the components of the fixing device 100. The states of the fixing device 100 include a standby state, a pre-conveyance state, a conveyance state, and a post-conveyance state of the recording medium R. For example, a machine state transits from the standby state to the pre-conveyance state (e.g., a first time), the conveyance state (e.g., a first time), the pre-conveyance state (e.g., a second time), the conveyance state (e.g., a second time), the post-conveyance state, and the standby state in this sequence.

The controller 200 receives a print job at a time T12 between the standby state and the pre-conveyance state (e.g., the first time). The fixing device 100 starts conveyance of a recording medium R at a time T14 after the pre-conveyance state (e.g., the first time). The fixing device 100 repeats a plurality of pre-conveyance states and conveyance states alternately.

States of the fixing roller 30 include a stop state and a rotation state. The fixing roller 30 stills in a period from a time T11 to the time T12. In the period, the fixing device 100 is in the standby state. The fixing roller 30 rotates in a period from the time T12 to a time T19. While the fixing device 100 is in the pre-conveyance states and the conveyance states, the fixing roller 30 rotates. The fixing roller 30 stops at the time T19. While the fixing device 100 is in the standby states, the fixing roller 30 stops. The controller 200 controls operations of the driving motor 91, changing the state of the fixing roller 30 between the rotation state and the stop state.

States of the pressure roller 40 include a pressure releasing state and a pressure application state. The pressure application state defines a state in which the recording medium R is conveyed through the nip portion 110 and a state in which the fixing roller 30 and the pressure roller 40 sandwich the recording medium R. In the pressure application state, the pressure roller 40 is pressed against the fixing roller 30 via the fixing belt 10. The pressure roller 40 applies pressure to the fixing roller 30.

The pressure releasing state defines a state in which the pressure roller 40 does not apply pressure to the fixing roller 30. In the pressure releasing state, the pressure roller 40 does not press against the fixing roller 30 via the fixing belt 10.

The pressure roller 40 is in the pressure releasing state in a period from the time T11 to the time T14. The pressure roller 40 is in the pressure application state in a period from the time T14 to a time T15. The pressure roller 40 is in the pressure releasing state in a period from the time T15 to a time T17. The pressure roller 40 is in the pressure application state in a period from the time T17 to a time T18. The pressure roller 40 is in the pressure releasing state in a period from the time T18 to a time T20.

The controller 200 controls the linear speed sensor 61 to detect the linear speed of the fixing belt 10 in a period from the time T12 to a time T13. The controller 200 calculates the amount of pressure applied by the pressure roller 40 in a period from the time T13 to the time T14. The thermal expansion calculating unit 220 calculates the amount of thermal expansion of the fixing roller 30 in the radial direction thereof based on the linear speed of the fixing belt 10. The controller 200 calculates the amount of pressure applied by the pressure roller 40 based on the amount of thermal expansion of the fixing roller 30 and a preset value of the nip width preset for the envelope to be conveyed through the fixing device 100. The controller 200 calculates the amount of pressure before the controller 200 starts conveyance of the recording medium R. The controller 200 controls the presser 50 to cause the pressure roller 40 to apply the calculated amount of pressure to the fixing roller 30.

The controller 200 conveys the recording medium R in the period from the time T14 to the time T15. The controller 200 starts a timer at the time T14. The controller 200 determines interruption of the print job in the period from the time T14 to the time T15.

The controller 200 controls the linear speed sensor 61 to detect the linear speed of the fixing belt 10 in a period from the time T15 to a time T16. The controller 200 calculates the amount of pressure applied by the pressure roller 40 in a period from the time T16 to the time T17.

The controller 200 conveys the recording medium R in the period from the time T17 to the time T18. The controller 200 starts the timer at the time T17. The controller 200 determines interruption of the print job in the period from the time T17 to the time T18.

While the recording medium R is conveyed through the fixing device 100, the fixing roller 30 may expand thermally, changing the nip width of the nip portion 110. In a case that the nip width changes, the controller 200 interrupts conveyance of the recording medium R. The controller 200 interrupts conveyance of the recording medium R in a first method, a second method, or a third method described below as a trigger.

In the first method, in a case that a predetermined period elapses after the controller 200 starts conveyance of the recording medium R, the controller 200 interrupts conveyance of the recording medium R.

In a case that the controller 200 determines that the fixing belt 10 rotates at a decreased linear speed before the recording medium R is conveyed through the fixing device 100, the fixing roller 30 may expand thermally with a decreased amount of thermal expansion. Hence, the controller 200 may predict an increased change rate of the amount of thermal expansion. Accordingly, in a case that the fixing roller 30 expands thermally with the decreased amount of thermal expansion, the controller 200 shortens a time taken until the controller 200 interrupts conveyance of the recording medium R in the second method.

In the third method, the controller 200 determines whether or not to interrupt conveyance of the recording medium R based on temperature change of the core metal 31. In a case that the core metal 31 has an increased temperature, compared to a case that the core metal 31 has a decreased temperature, the amount of thermal expansion of the fixing roller 30 increases. In a case that the controller 200 determines that temperature change of the core metal 31 exceeds a predetermined threshold, the controller 200 determines interruption of conveyance of the recording medium R.

A description is provided of processes of a control performed by the controller 200 before the controller 200 starts conveyance of the recording medium R.

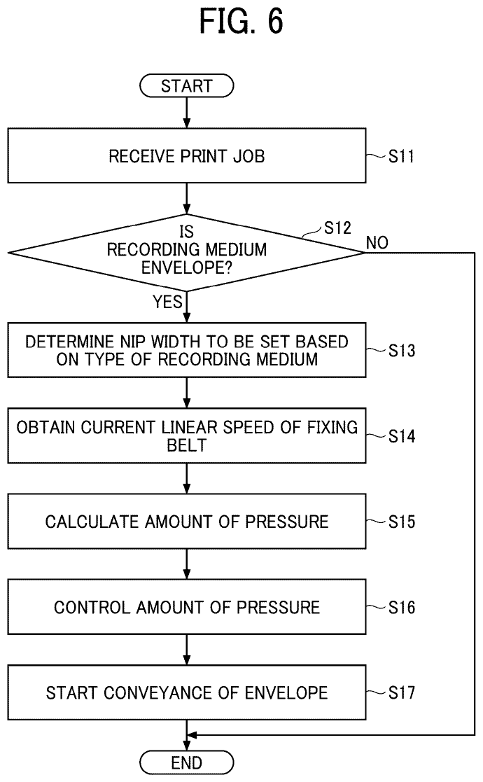

FIG. 6 is a flowchart illustrating the processes from reception of a print job until start of conveyance of a recording medium R. In step S11, the controller 200 receives the print job output from a printer driver. The print job includes data relating to a recording medium (e.g., the recording medium R) that passes through the nip portion 110. The data relating to the recording medium includes data relating to a type (e.g., a brand) of the recording medium and data relating to a size of the recording medium.

In step S12, the CPU 201 of the controller 200 determines whether or not the recording medium specified in the received print job is an envelope. If the recording medium is the envelope (YES in step S12), the controller 200 performs the process in step S13. If the recording medium is not the envelope (NO in step S12), the controller 200 ends the control depicted in FIG. 6.

In step S13, the controller 200 determines the nip width to be set based on the type of the recording medium specified in the print job. The memory of the controller 200 stores data relating to the nip width set for each type of the envelope. The memory stores in advance data indicating a relation between the type of the envelope and the nip width. For example, data relating to the type of the envelope includes data relating to a paper type, a size, and a thickness of the envelope.

In step S14, the controller 200 obtains data relating to a current linear speed of the fixing belt 10. The controller 200 receives the data relating to the linear speed of the fixing belt 10 from the linear speed sensor 61. The linear speed sensor 61 measures the linear speed of the fixing belt 10 in a state in which the pressure roller 40 separates from the fixing belt 10.

In step S15, the controller 200 calculates the amount of pressure applied by the pressure roller 40. The controller 200 calculates the amount of pressure applied by the pressure roller 40 based on the nip width preset for each type (e.g., brand) of the envelope and the current linear speed of the fixing belt 10. The thermal expansion calculating unit 220 calculates the amount of thermal expansion of the fixing roller 30 in the radial direction thereof based on the linear speed of the fixing belt 10.

In step S16, the controller 200 controls the presser 50, controlling the amount of pressure applied by the pressure roller 40. The controller 200 controls a position of the presser 50 to cause the pressure roller 40 to apply the calculated amount of pressure to the fixing roller 30. The controller 200 moves the pressure roller 40 to form the nip portion 110 having the preset nip width.

In step S17, the controller 200 starts conveyance of the envelope. For example, the controller 200 controls the driving motor 91 to drive and rotate the fixing roller 30. As the fixing roller 30 rotates the fixing belt 10, the fixing belt 10 and the pressure roller 40 convey the envelope.

Referring to FIG. 4, a description is provided of examples of calculation of the amount of pressure applied by the pressure roller 40.

FIG. 4 illustrates the relation between the current linear speed of the fixing belt 10 and the preset nip width of the nip portion 110. FIG. 4 illustrates a plurality of lines indicating amounts of pressure P11, P12, and P13. The amount of pressure P11 is 1,000. The amount of pressure P12 is 2,000. The amount of pressure P13 is 3,000. For example, the amounts of pressure P11, P12, and P13 are measured with a unit of msec. The amounts of pressure may be measured based on a rotation time of the cam 52, for example.

The controller 200 calculates the amount of pressure corresponding to the preset nip width based on a relation between an intersection of the current linear speed of the fixing belt 10 and the preset nip width, and obtained data.

A description is provided of a first example of calculation of the amount of pressure.

In the first example of calculation of the amount of pressure, the controller 200 identifies an amount of pressure, that is proximate to a current point PN11 in the obtained data. In the graph illustrated in FIG. 4, an intersection of a current linear speed V11 of the fixing belt 10 and a preset nip width NW12 defines the current point PN11. The current linear speed V11 of the fixing belt 10 defines data detected by the linear speed sensor 61. Preset nip widths NW11, NW12, and NW13 define values preset for types of the envelopes, respectively.

The controller 200 identifies a line that is proximate to the current point PN11 among obtained lines (e.g., curved lines) indicating amounts of pressure, respectively. The obtained lines (e.g., the curved lines) indicating the amounts of pressure define preset lines (e.g., curved lines) indicating the amounts of pressure, respectively.

As illustrated in FIG. 4, the controller 200 determines that the line indicating the amount of pressure P12 of 2,000 is proximate to the current point PN11. Thus, the controller 200 selects the line indicating the amount of pressure P12 of 2,000.

A description is provided of a second example of calculation of the amount of pressure.

In the second example of calculation of the amount of pressure, the controller 200 performs interpolation calculation (e.g., linear interpolation). The controller 200 performs linear computation based on a relation between a distance from the current point PN11 to the lines (e.g., the curved lines) that sandwich the current point PN11 vertically and the amount of pressure, thus calculating the amount of pressure. For example, the lines that sandwich the current point PN11 vertically define the line indicating the amount of pressure P11 that is distanced from the current point PN11 by a distance A and the line indicating the amount of pressure P12 that is distanced from the current point PN11 by a distance B. In FIG. 4, the controller 200 calculates an amount of pressure P of 1,667.

The second example of calculation of the amount of pressure obtains the nip width with improved accuracy compared to the first example of calculation of the amount of pressure. The first example of calculation of the amount of pressure has a decreased computational load compared to the second example of calculation of the amount of pressure.

A description is provided of a construction of a comparative fixing device.

The comparative fixing device includes a rotation detector that detects a rotational speed of a heating roller that rotates as an endless belt rotates. The comparative fixing device controls a rotational speed of a driving rotator that drives and rotates the endless belt based on a rotational speed of a driven rotator. The driving rotator is a fixing roller or a pressure roller. The comparative fixing device controls the rotational speed of the driving rotator with correction considering thermal expansion of the heating roller serving as the driven rotator.

The comparative fixing device may cause wrinkles on a recording medium after the recording medium passes through a fixing nip formed between the endless belt and the pressure roller.

A description is provided of advantages of the fixing device 100 according to the embodiment, that suppresses wrinkles on a recording medium.

The fixing device 100 according to the embodiment fixes a toner image on a recording medium R. The fixing device 100 includes the fixing belt 10 serving as the endless belt, the heating roller 20, the fixing roller 30, the pressure roller 40, the presser 50, the linear speed sensor 61, the thermal expansion calculating unit 220, and the control unit 210. The heating roller 20 heats the fixing belt 10. The fixing roller 30 includes the core metal 31 and the rubber layer 32 serving as an elastic layer. The rubber layer 32 is mounted on an outer circumference of the core metal 31. The fixing belt 10 is stretched across the heating roller 20 and the fixing roller 30. The pressure roller 40 is disposed opposite the outer circumferential face 30a of the fixing roller 30. The pressure roller 40 forms the nip portion 110 between the pressure roller 40 and the fixing belt 10 contacting the outer circumferential face 30a of the fixing roller 30. The recording medium R is conveyed through the nip portion 110. The presser 50 serving as a mover or a moving mechanism moves the pressure roller 40 with respect to the fixing roller 30 in the approach direction in which the pressure roller 40 approaches the fixing belt 10 and the separation direction in which the pressure roller 40 separates from the fixing belt 10. The linear speed sensor 61 serving as a sensor detects the linear speed of the fixing belt 10 in a state in which the pressure roller 40 separates from the fixing belt 10. The thermal expansion calculating unit 220 calculates the amount of thermal expansion of the fixing roller 30 in the radial direction thereof based on the linear speed of the fixing belt 10. The control unit 210 controls operations of the presser 50 based on the amount of thermal expansion of the fixing roller 30. The control unit 210 controls the amount of pressure applied by the pressure roller 40.

The fixing device 100 changes the nip width according to change in the amount of thermal expansion of the fixing roller 30. Hence, the fixing device 100 suppresses wrinkles on an envelope serving as the recording medium R.

A plurality of recording media serving as a plurality of recording media R conveyed through the nip portion 110 includes a first recording medium and a second recording medium that is conveyed through the nip portion 110 after the first recording medium. The linear speed sensor 61 detects a first linear speed of the fixing belt 10 before the first recording medium is conveyed through the nip portion 110. The thermal expansion calculating unit 220 calculates a first amount of thermal expansion of the fixing roller 30 in the radial direction thereof based on the first linear speed of the fixing belt 10. The control unit 210 determines a first nip width of the nip portion 110 in a circumferential direction of the pressure roller 40. The control unit 210 adjusts the amount of pressure applied by the pressure roller 40 based on the first amount of thermal expansion of the fixing roller 30. The control unit 210 conveys the first recording medium through the nip portion 110. After the first recording medium passes through the nip portion 110, the control unit 210 interrupts conveyance of the first recording medium. In an interruption period after the first recording medium passes through the nip portion 110 and before the control unit 210 starts conveyance of the second recording medium, the linear speed sensor 61 detects a second linear speed of the fixing belt 10. The thermal expansion calculating unit 220 calculates a second amount of thermal expansion of the fixing roller 30 in the radial direction thereof based on the second linear speed of the fixing belt 10. The control unit 210 determines a second nip width of the nip portion 110 in the circumferential direction of the pressure roller 40. The control unit 210 adjusts the amount of pressure applied by the pressure roller 40 based on the second amount of thermal expansion of the fixing roller 30. The control unit 210 conveys the second recording medium through the nip portion 110.

With the fixing device 100 having the construction described above, in the interruption period after the first recording medium passes through the nip portion 110 and before the second recording medium is conveyed through the nip portion 110, the linear speed sensor 61 measures the second linear speed of the fixing belt 10. The control unit 210 changes the nip width of the nip portion 110 based on the measured second linear speed of the fixing belt 10. Even if temperature change of the fixing roller 30 changes a coefficient of thermal expansion of the fixing roller 30 before the second recording medium is conveyed through the nip portion 110, the control unit 210 readjusts the nip width of the nip portion 110. As a result, the fixing device 100 suppresses wrinkles on the envelope serving as the recording medium R.

Alternatively, the linear speed sensor 61 of the fixing device 100 may detect a rotational speed of the fixing roller 30. Thus, the control unit 210 detects a linear speed of the fixing belt 10. The linear speed sensor 61 may detect a rotational speed of a rotation shaft of the fixing roller 30. The control unit 210 detects a linear speed of the fixing belt 10 based on the detected rotational speed of the rotation shaft of the fixing roller 30.

As illustrated in FIG. 1, the fixing device 100 further includes a driven roller 12 serving as a rotator that contacts an inner circumferential face 10a of the fixing belt 10 and rotates in accordance with rotation of the fixing belt 10. The linear speed sensor 61 detects a rotational speed of the driven roller 12 so that the control unit 210 detects a linear speed of the fixing belt 10. The fixing belt 10 has the inner circumferential face 10a that includes a part that contacts the outer circumferential face 30a of the fixing roller 30. The driven roller 12 that contacts the inner circumferential face 10a of the fixing belt 10 may be a tension roller that applies tension to the fixing belt 10, a guide roller that guides the fixing belt 10, or a heating roller that heats the fixing belt 10. The linear speed sensor 61 may detect a rotational speed of an outer circumferential face of the driven roller 12 that rotates in accordance with rotation of the fixing belt 10. The linear speed sensor 61 may detect an angle of rotation of a rotation shaft of the driven roller 12. The linear speed sensor 61 may detect a rotational speed of other rotator that rotates in accordance with rotation of the driven roller 12.

A plurality of recording media conveyed through the nip portion 110 includes a plurality of first recording media and a plurality of second recording media. When a predetermined period elapses after the control unit 210 starts conveyance of the first recording media, the control unit 210 interrupts conveyance of the first recording media. In an interruption period after the predetermined period elapses, the control unit 210 causes the linear speed sensor 61 to detect the linear speed of the fixing belt 10, readjusting the nip width of the nip portion 110. The control unit 210 defines the predetermined period based on experimental results and past performance. In a case that a plurality of recording media is conveyed through the fixing device 100, when the predetermined period elapses, wrinkles may generate on envelopes serving as the recording media easily. The fixing device 100 sets the predetermined period to interrupt conveyance of the recording media before wrinkles generate on the recording media. After the predetermined period elapses, the fixing device 100 interrupts conveyance of the recording media, readjusting the nip width of the nip portion 110.

The plurality of recording media conveyed through the nip portion 110 further includes a plurality of third recording media that is conveyed through the nip portion 110 after the second recording media. The control unit 210 performs a control below. For example, the control unit 210 conveys the plurality of first recording media in a first period. The control unit 210 conveys the plurality of second recording media in a second period after the first period. The control unit 210 conveys the plurality of third recording media in a third period after the second period. In a first interruption period between the first period and the second period, the linear speed sensor 61 detects the second linear speed of the fixing belt 10. In a second interruption period between the second period and the third period, the linear speed sensor 61 detects a third linear speed of the fixing belt 10. The second period is longer than the first period. The third period is longer than the second period.

Generally, in a case that the fixing roller 30 expands in a decreased amount of thermal expansion, compared to a case that the fixing roller 30 expands in an increased amount of thermal expansion, change in the amount of thermal expansion of the fixing roller 30 during conveyance of recording media is expected to increase. The fixing device 100 changes a period taken from a time when the fixing device 100 starts conveyance of the recording media until a time when the fixing device 100 interrupts conveyance of the recording media. The second period after the first period is longer than the first period. The third period after the second period is longer than the second period. Accordingly, the fixing device 100 decreases a number of interruptions of conveyance of the recording media. In a print job for printing on a plurality of envelopes, the fixing device 100 improves productivity.

The fixing device 100 further includes the temperature sensor 63 that detects the temperature of the fixing roller 30. Based on the temperature of the fixing roller 30, the control unit 210 determines the period taken from the time when the fixing device 100 starts conveyance of the recording media until the time when the fixing device 100 interrupts conveyance of the recording media. The fixing device 100 incorporating the temperature sensor 63 determines the period taken from the time when the fixing device 100 starts conveyance of the recording media until the time when the fixing device 100 interrupts conveyance of the recording media according to temperature change of the fixing roller 30. When the amount of thermal expansion of the fixing roller 30 changes according to temperature change of the fixing roller 30, the nip width of the nip portion 110 changes. The fixing device 100 interrupts conveyance of the recording media according to temperature change of the fixing roller 30. The control unit 210 controls the linear speed sensor 61 to detect the linear speed of the fixing belt 10 again, readjusting the nip width of the nip portion 110. Thus, the fixing device 100 suppresses wrinkles on the envelopes serving as the recording media.

A description is provided of a construction of the image forming apparatus 300 according to an embodiment of the present disclosure.

FIG. 7 is a schematic diagram of the image forming apparatus 300 according to the embodiment. The image forming apparatus 300 includes the fixing device 100 according to the embodiments described above.

The image forming apparatus 300 is a tandem color printer employing an electrophotographic method. The image forming apparatus 300 is a high speed printer including an image forming device 310 and a sheet feeder 320. The image forming device 310 is disposed in an upper portion of an apparatus body of the image forming apparatus 300. The sheet feeder 320 is disposed below the image forming device 310. The image forming device 310 includes the fixing device 100.

A description is provided of a construction of the image forming device 310.

The image forming device 310 includes an intermediate transfer belt 311 and photoconductors 312Y, 312M, 312C, and 312K. The photoconductor 312Y serves as an image bearer that bears a yellow (Y) toner image. The photoconductor 312M serves as an image bearer that bears a magenta (M) toner image. The photoconductor 312C serves as an image bearer that bears a cyan (C) toner image. The photoconductor 312K serves as an image bearer that bears a black (K) toner image. The image bearer may be a latent image bearer. The photoconductors 312Y, 312M, 312C, and 312K are arranged along an upper transfer face of the intermediate transfer belt 311.

Each of the photoconductors 312Y, 312M, 312C, and 312K is drum-shaped and rotates in an identical direction. The image forming device 310 further includes chargers 313Y, 313M, 313C, and 313K, developing devices 314Y, 314M, 314C, and 314K, and primary transfer devices 315Y, 315M, 315C, and 315K that surround the photoconductors 312Y, 312M, 312C, and 312K, respectively.

The developing devices 314Y, 314M, 314C, and 314K contain yellow, magenta, cyan, and black toners, respectively. The image forming device 310 further includes a unit constructed of optical writers 316Y and 316M and a unit constructed of optical writers 316C and 316K that are disposed in an uppermost portion of the image forming device 310.

The intermediate transfer belt 311 is stretched across a driving roller and driven rollers. The image forming device 310 further includes a secondary transfer opposed roller 317 and a secondary transfer roller 318. The secondary transfer roller 318 is disposed opposite the secondary transfer opposed roller 317 serving as one of the driven rollers. The image forming device 310 further includes a conveyance path through which a recording medium R is conveyed. The conveyance path extends from the secondary transfer roller 318 to the fixing device 100. The conveyance path is a horizontal path that extends substantially horizontally. The recording medium R is an envelope, for example. The recording medium R may be a sheet (e.g., a sheet of paper).

A description is provided of a construction of the sheet feeder 320.

The sheet feeder 320 includes a sheet tray 321 and a conveying mechanism. The sheet tray 321 loads a plurality of recording media R (e.g., sheets). The conveying mechanism separates an uppermost sheet from other sheets placed on the sheet tray 321 one by one and feeds the uppermost sheet to the secondary transfer roller 318.

A description is provided of image forming processes performed by the image forming apparatus 300.

The charger 313Y uniformly charges a surface of the photoconductor 312Y. The optical writer 316Y writes an electrostatic latent image on the photoconductor 312Y according to yellow image data. The developing device 314Y containing yellow (Y) toner visualizes the electrostatic latent image formed on the photoconductor 312Y as a yellow toner image. The primary transfer device 315Y applied with a predetermined bias primarily transfers the yellow toner image onto the intermediate transfer belt 311.

The above-described image forming processes are also performed on other photoconductors 312M, 312C, and 312K although the photoconductors 312M, 312C, and 312K bear toner images in different colors, that is, magenta, cyan, and black toner images, respectively. The primary transfer devices 315M, 315C, and 315K primarily transfer the magenta, cyan, and black toner images, respectively, onto the intermediate transfer belt 311 with an electrostatic force successively such that the magenta, cyan, and black toner images are superimposed on the yellow toner image.

The secondary transfer opposed roller 317 and the secondary transfer roller 318 secondarily transfer the yellow, magenta, cyan, and black toner images primarily transferred to the intermediate transfer belt 311 onto the recording medium R conveyed to the secondary transfer roller 318. Thus, a color toner image is formed on the recording medium R. The recording medium R transferred with the color toner image is conveyed to the fixing device 100.

As the pressure roller 40 is pressed against the fixing roller 30, the fixing roller 30 and the pressure roller 40 fix the color toner image on the recording medium R. The fixing roller 30 and the pressure roller 40 form the nip portion 110 between the fixing belt 10 and the pressure roller 40. As the recording medium R is conveyed through the nip portion 110, the fixing roller 30 and the pressure roller 40 fix the color toner image on the recording medium R. The image forming apparatus 300 further includes a stacker 331, photoconductor cleaners 319Y, 319M, 319C, and 319K, and a belt cleaner 332. The recording medium R discharged from the nip portion 110 is conveyed through an output path and is ejected onto the stacker 331.

The photoconductor cleaners 319Y, 319M, 319C, and 319K remove residual toner failed to be primarily transferred onto the intermediate transfer belt 311 and therefore remaining on the photoconductors 312Y, 312M, 312C, and 312K therefrom, respectively. The belt cleaner 332 removes residual toner and the like failed to be secondarily transferred onto the recording medium R and therefore remaining on the intermediate transfer belt 311 therefrom. Thus, the image forming apparatus 300 is ready for a next print job.

The above describes the embodiments of the present disclosure in detail. However, the technology of the present disclosure is not limited to the embodiments described above. Various modifications and substitutions may be applied to the above-described embodiments within the scope of the technology of the present disclosure.

The functional units executed by the controller 200 according to the embodiments described above are established by one or more processing circuitry. The processing circuitry according to the embodiments of the present disclosure encompasses a processor programmed to execute the functional units with software like a central processing unit (CPU) implemented by an electronic circuit. The processing circuitry further encompasses a device designed to execute the functional units described above, such as an application-specific integrated circuit (ASIC), a digital signal processor (DSP), a field programmable gate array (FPGA), and a general circuit module.

A description is provided of aspects of the embodiments of the present disclosure.

A description is provided of a first aspect of the embodiments of the present disclosure.

As illustrated in FIGS. 1 to 3, a fixing device (e.g., the fixing device 100) includes a fixing belt (e.g., the fixing belt 10), a heating roller (e.g., the heating roller 20), a fixing roller (e.g., the fixing roller 30), a pressure roller (e.g., the pressure roller 40), a mover (e.g., the presser 50), a sensor (e.g., the linear speed sensor 61), and a controller (e.g., the controller 200).

The fixing device fixes a toner image on at least one recording medium (e.g., the recording medium R). The fixing belt is an endless belt that is stretched across the heating roller and the fixing roller. For example, the heating roller and the fixing roller serve as support rollers that support the fixing belt rotatably. The heating roller heats the fixing belt. The fixing roller includes a core metal (e.g., the core metal 31) and an elastic layer (e.g., the rubber layer 32) mounted on an outer circumference of the core metal. The pressure roller is disposed opposite an outer circumferential face (e.g., the outer circumferential face 30a) of the fixing roller via the fixing belt. The pressure roller is pressed against the fixing roller via the fixing belt to form a nip portion (e.g., the nip portion 110) between the fixing belt and the pressure roller. The recording medium is conveyed through the nip portion. The mover moves the pressure roller with respect to the fixing roller in an approach direction in which the pressure roller approaches the fixing belt and a separation direction in which the pressure roller separates from the fixing belt. The sensor detects a linear speed of the fixing belt in a state in which the pressure roller separates from the fixing belt. The controller includes a thermal expansion calculating portion (e.g., the thermal expansion calculating unit 220) and a control portion (e.g., the control unit 210). The thermal expansion calculating portion calculates an amount of thermal expansion of the fixing roller in a radial direction thereof based on the linear speed of the fixing belt. The control portion controls the mover to move the pressure roller based on the amount of thermal expansion of the fixing roller to adjust an amount of pressure applied by the pressure roller to the fixing roller.

According to the embodiments of the present disclosure, the heater 25 is disposed inside the heating roller 20. Alternatively, the heater 25 may be disposed at other positions. For example, the heater 25 may be disposed inside the fixing roller 30 or disposed opposite the inner circumferential face 10a or an outer circumferential face of the fixing belt 10.

A description is provided of a second aspect of the embodiments of the present disclosure.

In the fixing device according to the first aspect, the at least one recording medium includes a first recording medium and a second recording medium that is conveyed through the nip portion after the first recording medium. The sensor detects a first linear speed of the fixing belt before the first recording medium is conveyed through the nip portion. The thermal expansion calculating portion calculates a first amount of thermal expansion of the fixing roller based on the first linear speed of the fixing belt. The nip portion has a nip width in a circumferential direction of the pressure roller. The control portion determines a first nip width of the nip portion in the circumferential direction of the pressure roller. The control portion adjusts the amount of pressure applied by the pressure roller based on the first amount of thermal expansion of the fixing roller. The control portion conveys the first recording medium through the nip portion. After the first recording medium passes through the nip portion, the control portion interrupts conveyance of the first recording medium. In an interruption period after the first recording medium passes through the nip portion and before the control portion starts conveyance of the second recording medium, the sensor detects a second linear speed of the fixing belt. The thermal expansion calculating portion calculates a second amount of thermal expansion of the fixing roller based on the second linear speed of the fixing belt. The control portion determines a second nip width of the nip portion in the circumferential direction of the pressure roller. The control portion adjusts the amount of pressure applied by the pressure roller based on the second amount of thermal expansion of the fixing roller. The control portion conveys the second recording medium through the nip portion.

A description is provided of a third aspect of the embodiments of the present disclosure.

In the fixing device according to the first aspect or the second aspect, the sensor detects a rotational speed of the fixing roller to detect the linear speed of the fixing belt.

A description is provided of a fourth aspect of the embodiments of the present disclosure.

In the fixing device according to any one of the first aspect to the third aspect, as illustrated in FIG. 1, the fixing device further includes a rotator (e.g., the driven roller 12) that contacts an inner circumferential face (e.g., the inner circumferential face 10a) of the fixing belt. The rotator rotates in accordance with rotation of the fixing belt. The sensor detects a rotational speed of the rotator to detect the linear speed of the fixing belt.

A description is provided of a fifth aspect of the embodiments of the present disclosure.

In the fixing device according to the second aspect, the at least one recording medium includes a plurality of first recording media and a plurality of second recording media. When a predetermined period elapses after the control portion starts conveyance of the first recording media, the control portion interrupts conveyance of the first recording media.

A description is provided of a sixth aspect of the embodiments of the present disclosure.

In the fixing device according to the second aspect, the at least one recording medium further includes a plurality of third recording media that is conveyed through the nip portion after the second recording media. The control portion performs a control below. For example, the control portion conveys the plurality of first recording media in a first period. The control portion conveys the plurality of second recording media in a second period. The control portion conveys the plurality of third recording media in a third period. In a first interruption period after the first period and before the second period, the sensor detects the second linear speed of the fixing belt. In a second interruption period after the second period and before the third period, the sensor detects a third linear speed of the fixing belt. The second period is longer than the first period. The third period is longer than the second period.

A description is provided of a seventh aspect of the embodiments of the present disclosure.

The fixing device according to any one of the first aspect to the sixth aspect further includes a temperature sensor (e.g., the temperature sensor 63) that detects a temperature of the fixing roller. The control portion determines a length of a period taken from a time when the control portion starts conveyance of the at least one recording medium until a time when the control portion interrupts conveyance of the at least one recording medium based on the temperature of the fixing roller.

A description is provided of an eighth aspect of the embodiments of the present disclosure.

An image forming apparatus (e.g., the image forming apparatus 300) includes the fixing device according to any one of the first aspect to the seventh aspect.

According to the embodiments described above, the image forming apparatus 300 is a printer. Alternatively, the image forming apparatus 300 may be a copier, a facsimile machine, a multifunction peripheral (MFP) having at least two of copying, printing, scanning, facsimile, and plotter functions, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A fixing device comprising:
a fixing belt that is endless;
a heater to heat the fixing belt;
a support roller supporting the fixing belt rotatably;
a fixing roller supporting the fixing belt rotatably;
a pressure roller to press against the fixing roller via the fixing belt to form a nip portion between the fixing belt and the pressure roller, the nip portion through which at least one recording medium is conveyed;
a mover to move the pressure roller with respect to the fixing roller in an approach direction in which the pressure roller approaches the fixing belt and a separation direction in which the pressure roller separates from the fixing belt;
a linear speed sensor to detect a linear speed of the fixing belt in a state in which the pressure roller separates from the fixing belt; and
processing circuitry configured to:
calculate an amount of thermal expansion of the fixing roller in a radial direction of the fixing roller based on the linear speed of the fixing belt; and
control the mover to move the pressure roller based on the amount of thermal expansion of the fixing roller to adjust an amount of pressure applied by the pressure roller to the fixing roller.

2. The fixing device according to claim 1,
wherein the heater is disposed inside the support roller and heats the support roller.

3. The fixing device according to claim 1,
wherein the fixing roller includes:
a core metal; and
an elastic layer mounted on an outer circumference of the core metal.

4. The fixing device according to claim 1,
wherein the at least one recording medium includes at least one first recording medium and at least one second recording medium that is conveyed through the nip portion after the at least one first recording medium,
wherein the linear speed sensor detects a first linear speed of the fixing belt before the at least one first recording medium is conveyed through the nip portion,
wherein the processing circuitry is configured to:
calculate a first amount of thermal expansion of the fixing roller based on the first linear speed of the fixing belt;
determine a first nip width of the nip portion in a circumferential direction of the pressure roller;
adjust the amount of pressure applied by the pressure roller based on the first amount of thermal expansion of the fixing roller;
convey the at least one first recording medium through the nip portion; and
interrupt conveyance of the at least one first recording medium after the at least one first recording medium passes through the nip portion,
wherein, in an interruption period after the at least one first recording medium passes through the nip portion and before the processing circuitry starts conveyance of the at least one second recording medium, the linear speed sensor detects a second linear speed of the fixing belt, and
wherein the processing circuitry is configured to:
calculate a second amount of thermal expansion of the fixing roller based on the second linear speed of the fixing belt;
determine a second nip width of the nip portion in the circumferential direction of the pressure roller;
adjust the amount of pressure applied by the pressure roller based on the second amount of thermal expansion of the fixing roller; and
convey the at least one second recording medium through the nip portion.

5. The fixing device according to claim 4,
wherein the at least one first recording medium includes a plurality of first recording media and the at least one second recording medium includes a plurality of second recording media.

6. The fixing device according to claim 5,
wherein, when a predetermined period elapses after the processing circuitry starts conveyance of the plurality of first recording media, the processing circuitry is configured to interrupt conveyance of the plurality of first recording media.

7. The fixing device according to claim 6,
wherein the at least one recording medium further includes a plurality of third recording media that is conveyed through the nip portion after the plurality of second recording media.

8. The fixing device according to claim 7,
wherein the processing circuitry is configured to:
convey the plurality of first recording media in a first period;
convey the plurality of second recording media in a second period; and
convey the plurality of third recording media in a third period,
wherein the linear speed sensor detects the second linear speed of the fixing belt in a first interruption period after the first period and before the second period, and detects a third linear speed of the fixing belt in a second interruption period after the second period and before the third period, and
wherein the second period is longer than the first period and the third period is longer than the second period.

9. The fixing device according to claim 1,
wherein the linear speed sensor detects a rotational speed of the fixing roller to detect the linear speed of the fixing belt.

10. The fixing device according to claim 1, further comprising a rotator contacting an inner circumferential face of the fixing belt, the rotator to rotate in accordance with rotation of the fixing belt.

11. The fixing device according to claim 10,
wherein the linear speed sensor detects a rotational speed of the rotator to detect the linear speed of the fixing belt.

12. The fixing device according to claim 10,
wherein the rotator includes a roller.

13. The fixing device according to claim 1, further comprising a temperature sensor to detect a temperature of the fixing roller.

14. The fixing device according to claim 13,
wherein the processing circuitry is configured to determine a length of a period taken from a time when the processing circuitry starts conveyance of the at least one recording medium until a time when the processing circuitry interrupts conveyance of the at least one recording medium based on the temperature of the fixing roller.

15. The fixing device according to claim 1, further comprising a driving motor coupled with the processing circuitry, the driving motor to drive and rotate the fixing roller,
wherein the fixing roller rotates the fixing belt to convey the at least one recording medium.

16. An image forming apparatus comprising:
an image bearer to bear an image; and
a fixing device to fix the image on at least one recording medium, the fixing device including:
a fixing belt that is endless;
a heater to heat the fixing belt;
a support roller supporting the fixing belt rotatably;
a fixing roller supporting the fixing belt rotatably;
a pressure roller to press against the fixing roller via the fixing belt to form a nip portion between the fixing belt and the pressure roller, the nip portion through which the at least one recording medium is conveyed;
a mover to move the pressure roller with respect to the fixing roller in an approach direction in which the pressure roller approaches the fixing belt and a separation direction in which the pressure roller separates from the fixing belt;
a linear speed sensor to detect a linear speed of the fixing belt in a state in which the pressure roller separates from the fixing belt; and
processing circuitry configured to:
calculate an amount of thermal expansion of the fixing roller in a radial direction of the fixing roller based on the linear speed of the fixing belt; and
control the mover to move the pressure roller based on the amount of thermal expansion of the fixing roller to adjust an amount of pressure applied by the pressure roller to the fixing roller.

17. A fixing method comprising:
receiving a print job;
determining that a recording medium specified in the print job is an envelope;
determining a nip width of a nip portion formed between a fixing belt and a pressure roller to be set based on a type of the envelope, the nip width being in a circumferential direction of the pressure roller;
obtaining a current linear speed of the fixing belt;
calculating an amount of pressure applied by the pressure roller based on the nip width preset for the type of the envelope and the current linear speed of the fixing belt;
controlling the amount of pressure applied by the pressure roller; and
starting conveyance of the envelope.
